(19) United States
(12) Patent Application Publication
(10) Pub. No.: US 2024/0349084 A1
(43) Pub. Date: Oct. 17, 2024

(54) METHODS, APPARATUS, AND SYSTEMS FOR ENABLING INDIRECT-TO-DIRECT PATH SWITCHING AT LAYER-3 (L3) USER EQUIPMENT (UE)-TO-UE RELAY

(71) Applicant: InterDigital Patent Holdings, Inc., Wilmington, DE (US)

(72) Inventors: Michelle PERRAS, Montréal (CA); Taimoor ABBAS, Sainte-Julie (CA); Samir FERDI, Kirkland (CA); Xiaoyan SHI, Lake Oswego, OR (US)

(21) Appl. No.: 18/681,348

(22) PCT Filed: Aug. 3, 2022
(86) PCT No.: PCT/US2022/039295

§ 371 Date: Feb. 5, 2024

Related U.S. Application Data
(60) Provisional application No. 63/230,334, filed on Aug. 6, 2021.

(51) Int. Cl. H04W 24/02; H04W 92/18

(52) U.S. Cl. CPC H04W 24/02; H04W 92/18

(57) ABSTRACT

Methods, apparatus and systems are disclosed. One method may be implemented by a first Wireless Transmit/Receive Unit (WTRU) having established an indirect link with a second WTRU. The method may include performing a Discovery procedure and detecting, based on a result of the performed Discovery procedure, that the second WTRU is directly reachable. The method may further include initiating establishment of a direct link, switching from the indirect link to the direct link and communicating, by the first WTRU with the second WTRU, using the established direct link after the switch.

### CROSS REFERENCE TO RELATED APPLICATIONS

This application claims the benefit of U.S. Provisional Application No. 63/230,334, filed Aug. 6, 2021. The contents of this prior application are incorporated herein by reference in its entirety.

### FIELD

Embodiments disclosed herein generally relate to wireless communications and, for example to methods, apparatus and systems for enabling indirect-to-direct path or direct-to indirect switching at layer-3 UE-to-UE relay.

### BRIEF DESCRIPTION OF THE DRAWINGS

A more detailed understanding may be had from the detailed description below, given by way of example in conjunction with drawings appended hereto. Figures in the description, are examples. As such, the Figures and the detailed description are not to be considered limiting, and other equally effective examples are possible and likely. Furthermore, like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a diagram illustrating a representative UE-to-UE Relay using IP Routing;

FIG. 3 is a diagram illustrating a representative Layer-3 based UE-to-UE Relay Re-selection;

FIG. 4 is a diagram illustrating a representative indirect-to-direct Path Switching, for example triggered during direct link establishment using a message;

FIG. 5 is a diagram illustrating a representative indirect-to-direct Path Switching, for example triggered after direct link establishment using a PC5 signaling message;

FIG. 6 is a diagram illustrating a representative indirect-to-direct Path Switching triggered during direct link establishment using a DSM Command message;

FIG. 7 is a diagram illustrating a representative direct-to-indirect Path Switching;

FIG. 8 is a flowchart illustrating a representative method;

FIG. 9 is a flowchart illustrating a representative method; and

FIG. 10 is a flowchart illustrating a representative method.

### DETAILED DESCRIPTION

### Example Networks for Implementation of the Embodiments

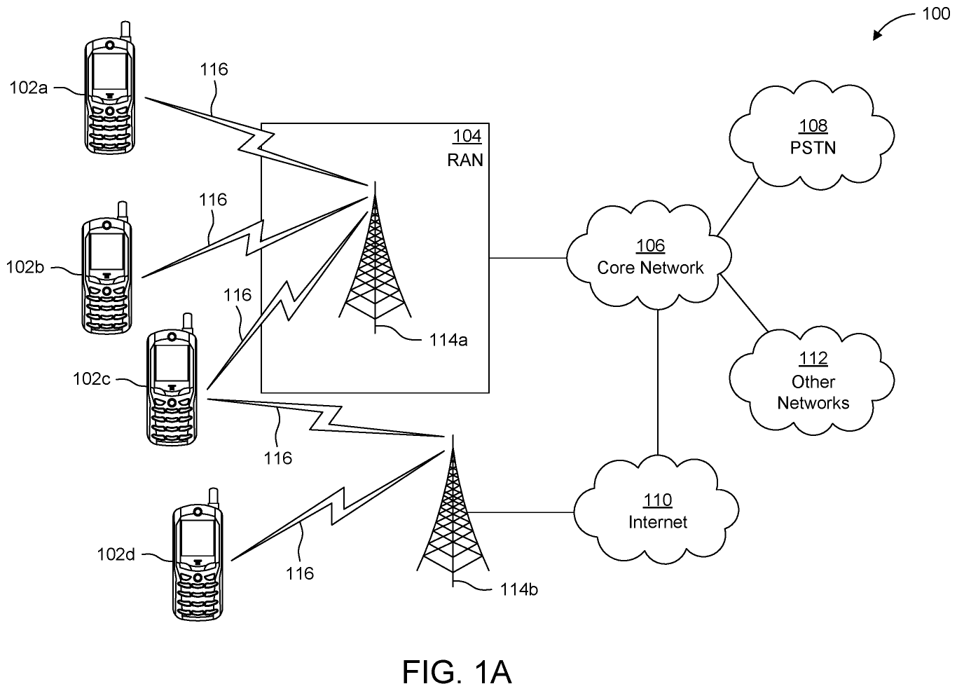

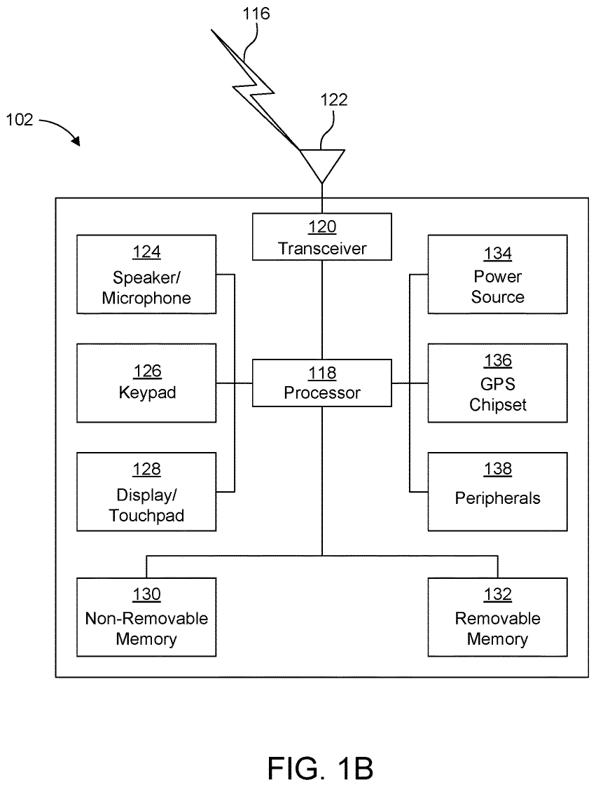

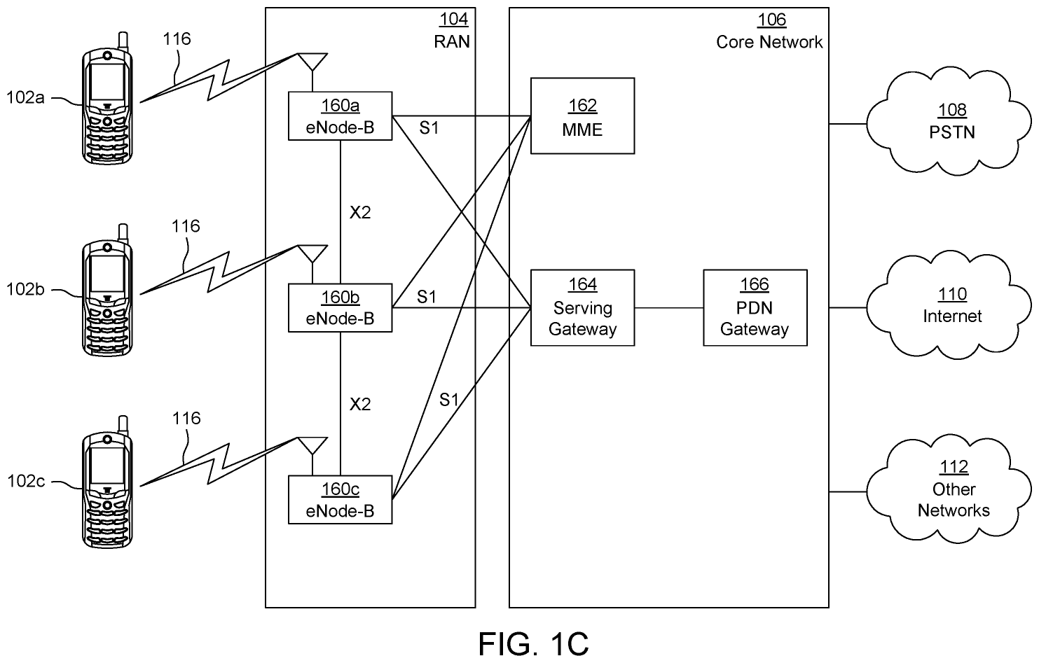

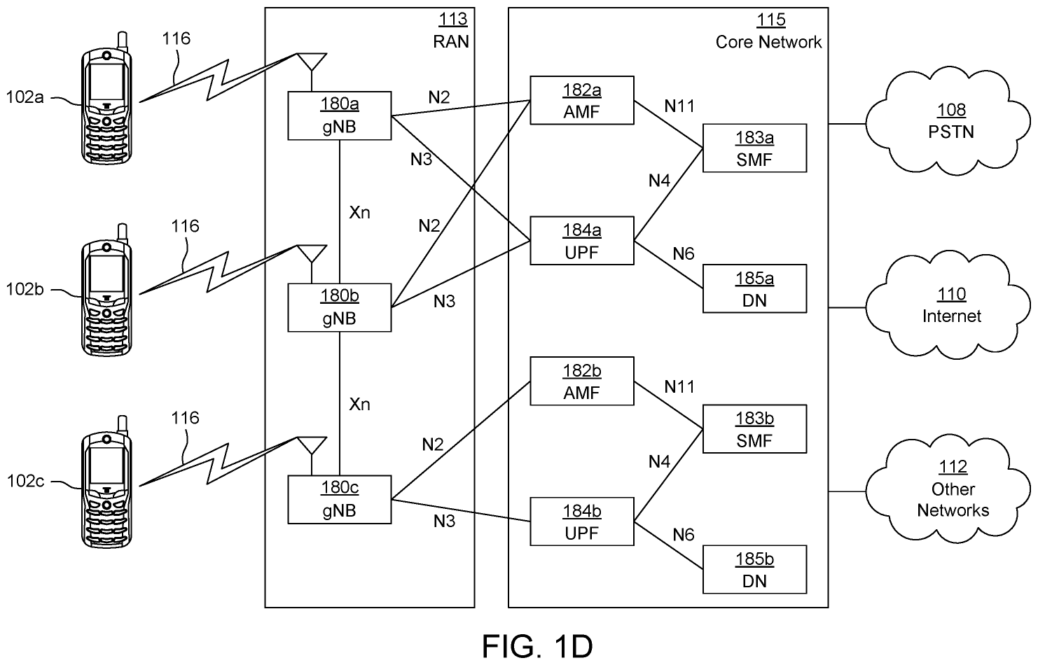

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B (end), a Home Node B (HNB), a Home eNode B (HeNB), a gNB, a NR Node B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The processor 118 of the WTRU 102 may operatively communicate with various peripherals 138 including, for example, any of: the one or more accelerometers, the one or more gyroscopes, the USB port, other communication interfaces/ports, the display and/or other visual/audio indicators to implement representative embodiments disclosed herein.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode Bs 160a, 160b, 160c, though it will be appreciated that the RAN 104 may include any number of eNode Bs while remaining consistent with an embodiment. The eNode Bs 160a, 160b, 160c may each include one or more transceivers for communicating with the WTRUs 102a, 102b, 102c over the air interface 116. In one embodiment, the eNode Bs 160a, 160b, 160c may implement MIMO technology. Thus, the eNode B 160a, for example, may use multiple antennas to transmit wireless signals to, and/or receive wireless signals from, the WTRU 102a.

Each of the eNode Bs 160a, 160b, 160c may be associated with a particular cell (not shown) and may be configured to handle radio resource management decisions, handover decisions, scheduling of users in the UL and/or DL, and the like. As shown in FIG. 1C, the eNode Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped onto the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 180b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode Bs 160a, 160b, 160c. For example, WTRUs 102a, 102b, 102c may implement DC principles to communicate with one or more gNBs 180a, 180b, 180c and one or more eNode Bs 160a, 160b, 160c substantially simultaneously. In the non-standalone configuration, eNode Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements is depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different Protocol Data Unit (PDU) sessions with different requirements), selecting a particular SMF 183a, 183b, management of the registration area, termination of Non-Access Stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency communication (URLLC) access, services relying on enhanced mobile (e.g., massive mobile) broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In certain representative embodiments, methods, apparatus and systems may be implement, for example for an indirect-to-direct path switching. For example, a source UE may initiate a direct link establishment procedure and an indirect-to-direct path switching by including indirect link info (e.g., information) in a first message (e.g., a Direct Communication Request (DCR) message and/or a Direct Security Mode (DSM) Complete message). The source UE may detect that the source UE has (e.g., currently has) an indirect link with a target UE when receiving a second message (e.g., a Direct Communication Accept (DCA) message for the direct link establishment). The source UE may initiate an indirect-to-direct path switching, for example, by sending a third message (e.g., an updated Link Modification Request message) in and/or over a direct link with indirect link information. The source UE may detect that the source UE has (e.g., currently has) an indirect link with the target UE when receiving the first message (e.g., the DCR message) from the target UE. The source UE may initiate an indirect-to-direct path switching, for example by including path switching info (e.g., information) in a fourth message (e.g., a DSM Command message).

In certain representative embodiments, the methods, apparatus and systems may implement, for example a direct-to-indirect path switching. For example, a first UE (e.g., UE1 may initiate a direct-to-indirect path switching, for example by sending a first message (e.g., a Link Modification Request message) in and/or over the direct link, which may include an indication (e.g., any of: (1) a “direct-to-indirect” indication, (2) a “keep-IP-addr” indication, (3) a threshold and/or (4) a “preparation” indication, among others. The path switching may be done/completed immediately after completion of the Link Modification procedure, or may be completed once (e.g., only once) a threshold is met or the link is lost. The first UE (e.g., UE1) and/or the second UE (e.g., UE2) may continue to monitor the link quality on and/or over the direct link after switching to the indirect link. If the direct link quality is improving, a path switching may be done/completed from an indirect link to a direct link.

In certain representative embodiments, the methods, apparatus and systems may implement, for example a capabilities exchange. The first UE (e.g., UE1) and the second UE (e.g., UE2) may indicate if they support path switching, multiple paths and/or seamless continuity during a Discovery procedure and/or during a link establishment procedure.

Representative Procedures for L3 UE-to-UE Relay that May be IP Traffic Enabled

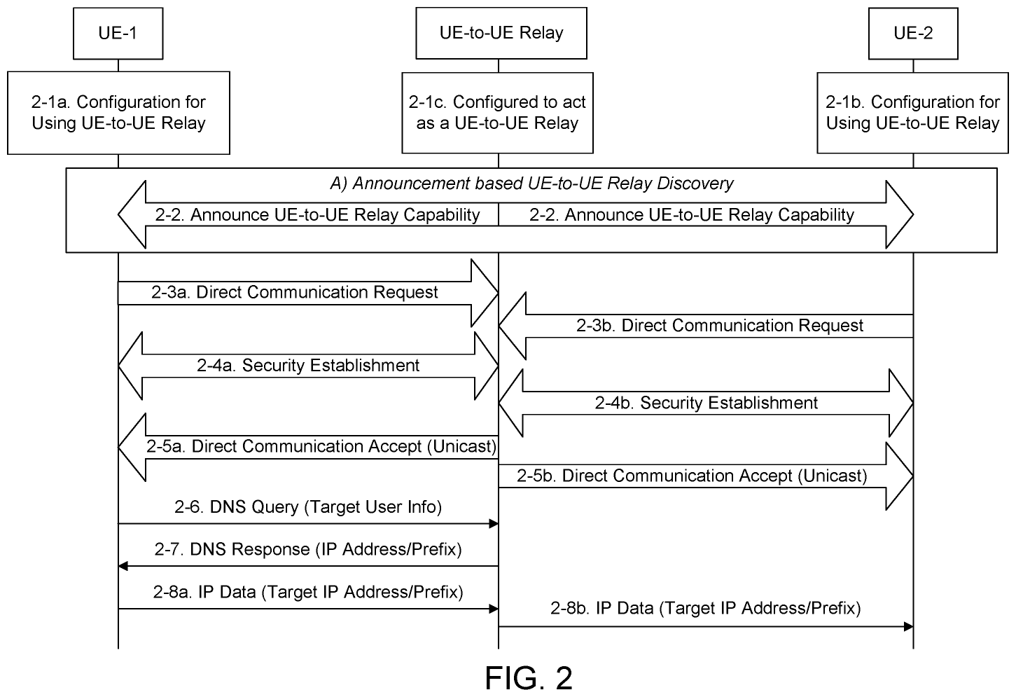

FIG. 2 is a diagram illustrating a representative UE-to-UE Relay using IP Routing. For an L3 UE-to-UE Relay which is based on IP routing, any UE that may want to make use of a ProSe 5G UE-to-UE Relay may need to establish a unicast L2 link (e.g., a PC5 unicast link) with the UE-to-UE Relay. As part of a unicast L2 link establishment procedure, the ProSe 5G UE-to-UE Relay may allocate an IP address/prefix to the UE and may store an association of the User info (e.g., User information) of the UE and/or an allocated IP address/prefix into one or more Domain Name Server/System (DNS) entries of the UE. The ProSe 5G UE-to-UE Relay may act as a DNS server.

As illustrated in the example of FIG. 2, at 2-1a and 2-1b, UE-1 and UE-2 may respectively be configured to use a UE-to-UE relay. At 2-1c, the UE-to-UE Relay may be configured to act as the UE-to-UE relay. FIG. 2 illustrates an example that includes announcement-based UE-to-UE relay discovery, where the UE-to-UE Relay may, at 2-2, announce UE-to-UE relay capability to UE-1 and/or UE-2. At 2-3a and 2-3b, UE-1 and UE-2 may respectively send a direct communication request to the UE-to-UE Relay. At 2-4a and 2-4b, UE-1 and UE-2 may perform security establishment with the UE-to-UE Relay. At 2-5a and 2-5b, the UE-to-UE Relay may send a direct communication accept message to UE-1 and/or UE-2.

In the example of FIG. 2, at 2-6, UE-1 may send a DNS query to the UE-to-UE Relay. The DNS query may include target user information. At 2-7, the UE-to-UE Relay may send a DNS response, to UE-1, which may include an IP address and/or prefix. At 2-8a, UE-1 may send IP data including a target IP address and/or prefix to the UE-to-UE Relay. At 2-8b, the UE-to-UE Relay may forward the IP data including the target IP address and/or prefix to UE-2.

In some examples, the UE may obtain an IP address from another entity than the Relay. In this case, the UE may register an IP address of the UE at the Relay and/or the Relay may store this association. When a first UE (e.g., a source UE) needs to or is to communicate with another UE (e.g., a target UE) or the first UE needs to or is to discover a ProSe service via the ProSe 5G UE-to-UE Relay, the first UE may send a DNS query to the ProSe 5G UE-to-UE Relay over the unicast link (1) for the target UE (e.g., based on the User Info of the target UE), which may return the IP address/prefix of the target UE or the ProSe Service or (2) for the ProSe Service, which may return a list of IP addresses/prefixes of target UEs supporting the ProSe Service. For the first situation, the source UE may know the user info of the target UE and/or the target UE might not know the user info of the source UE. In the second situation, the source UE and the target UE may not know the user info of their peer UE.

The source UE may send IP data, or non-IP data encapsulated in IP, to the target UE via a unicast L2 link to the UE-to-UE Relay that returned the IP address/prefix of the target UE. The UE-to-UE Relay may act as an IP router, and may forward the packets to the corresponding unicast L2 link towards the target UE. Each of the unicast L2 links may be treated as an IP interface.

### Representative Procedures for Path Switching Between Two Relays (e.g., Using Indirect-to-Indirect Links)

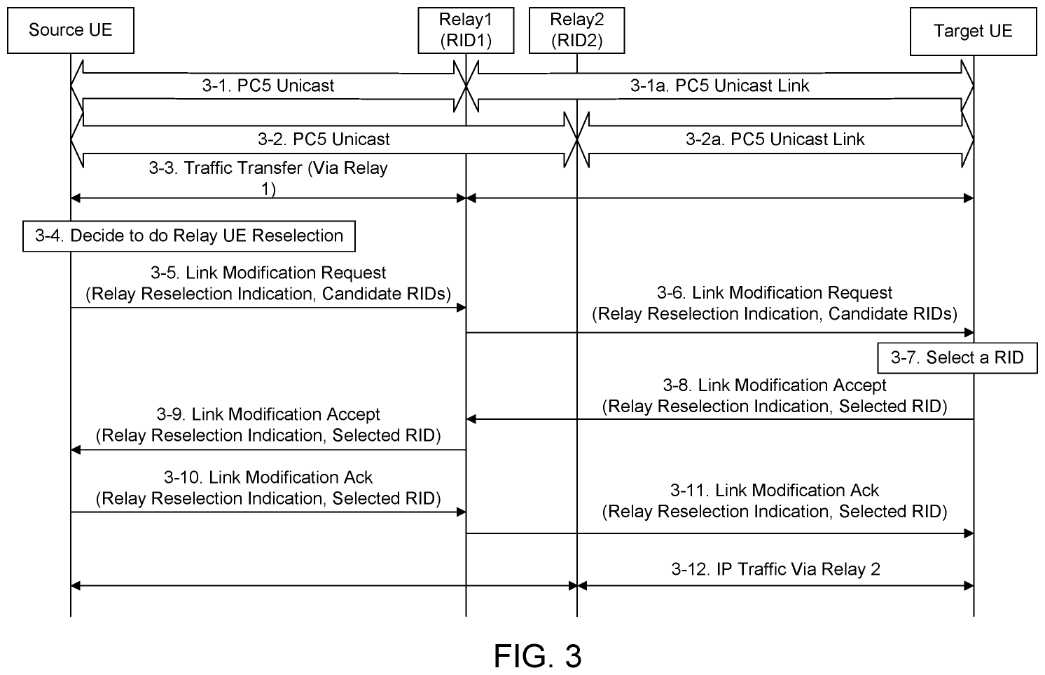

FIG. 3 is a diagram illustrating a representative Layer-3 based UE-to-UE Relay Re-selection. Referring to FIG. 3, UE-to-UE Relay reselection with two L3 Relays may be used. The source UE or the target UE may initiate the relay reselection procedure and the source UE and the target UE may negotiate UE-to-UE Relay reselection using an existing relay connection. The Link Modification procedure (e.g., via a plurality of messages such as Request/Accept/Ack messages) may be used for the relay reselection negotiation and exchange of IP addresses used with the selected relay.

As illustrated in the example of FIG. 3, at 3-1 and 3-1a, the source UE and target UE may establish a PC5 unicast link with Relay 1. Similarly, at 3-2 and 3-2a, the source UE and target UE may establish a PC5 unicast link with Relay 2. At 3-3, traffic transfer between the source UE and target UE may be performed via Relay 1. At 3-4, the source UE may decide to perform relay UE reselection and, at 3-5, may send a link modification request including a relay reselection indication and/or candidate RIDs to Relay1, to be forwarded to target UE. In turn, at 3-6, Relay1 may forward the link modification request with the relay reselection indication and/or candidate RIDs to the target UE. At 3-7, the target UE may select a RID and, at 3-8, may send a link modification accept including a relay reselection indication and/or the selected RID to Relay 1, to be forwarded to source UE. Then, at 3-9, Relay 1 may forward the link modification accept including the relay reselection indication and/or the selected RID to the source UE. At 3-10, the source UE may send a link modification acknowledgement including the relay reselection indication and/or selected RID to Relay1, to be forwarded to target UE. At 3-11, Relay 1 may forward the link modification acknowledgement to the target UE. At 3-12, the target UE and/or source UE may begin to send IP traffic via the selected RID (e.g., Relay 2 in the example of FIG. 3).

The Layer-3 UE-to-UE Relay operations illustrated in FIGS. 2 and 3 support relaying traffic between two end-to-end peer UEs via two PC5 unicast links and path switching from an indirect link via a Relay to another indirect link via another Relay.

### Representative Procedures for Indirect-to-Direct Path Switching

Indirect communication (e.g., PC5 indirect communication using PC5 communications via a U2U Relay) may be used when a source UE and a target UE are not in proximity of each other. Once a PC5 link is established via a Relay, the source UE and/or target UE may communicate (e.g., exchange traffic). For example, while communicating via this indirect link, the source UE and target UE may move closer to each other, allowing the establishment of a direct PC5 unicast link (e.g., a PC5 link without going through a U2U relay). UEs may be configured with policies which prefer direct links over indirect links, e.g., for efficiency reasons. In this case, procedures and/or operations may be implemented such that the source and target UEs may switch traffic from an indirect link to a direct PC5 unicast link (e.g., by performing a path switching, for example for service continuity). For indirect links via a L3 Relay, the source UE may know and/or determine the target UE user info (e.g., information) while the target UE may not know the source UE user info (e.g., information). It is also possible that neither the source UE nor the target UE knows/can determine the peer UE user info in the case where the peer UE IP address is learned via a DNS Query specifying a ProSe Service.

In certain representative embodiments, methods, systems, apparatus, procedure, and/or operations may be implemented for the source UE to: (1) detect that its indirect peer UE is directly reachable. (2) establish a direct link with the indirect peer UE and/or (3) associate the direct link with the existing indirect link on its side and on the peer UE side for indirect-to-direct path switching.

In certain representative embodiments, methods, systems, apparatus, procedure, and/or operations may be implemented to support seamless continuity while switching from an indirect-to-direct path (e.g., which is transparent to the Application layer). For example, to obtain seamless continuity, the UEs communicating via the Relay using IP routing may need to preserve or may reuse their IP addresses when switching to direct communication.

In certain representative embodiments, methods, systems, apparatus, procedure, and/or operations may be implemented for the source UE to obtain seamless continuity when doing indirect to-direct path switching.

In certain representative embodiments, methods, systems, apparatus, procedure, and/or operations may be implemented to support the establishment of a direct link in addition to the indirect link and/or to use the direct link and the indirect link simultaneously and/or concurrently (e.g., for additional bandwidth) and/or per service type (e.g., using the direct link for PC5 signaling and the indirect link for traffic (e.g., data)) or keeping one as a backup link (e.g., for redundancy, using the direct link and reverting to the indirect link, if the direct link is lost or has poor link quality). The additional link, for example may support more than one indirect link.

In certain representative embodiments, methods, systems, apparatus, procedure, and/or operations may be implemented for the source UE to associate an additional path (e.g., direct/indirect link) to an existing path (e.g., direct/indirect link) with a peer UE (e.g., multiple paths may be supported for increased bandwidth, for traffic type-based paths and/or for backup paths).

### Representative Procedures for Direct-to-Indirect Path Switching

For a direct communication (e.g., via a PC5 link), after the PC5 link is established, the source and target UEs may exchange traffic. While communicating via this direct link, the source and target UEs may move away from each other, requiring/facilitating an establishment of an indirect PC5 link (e.g., a unicast link), for example a PC5 link going through a U2U relay. In certain examples, direct-to-indirect path switching may not be implemented. In other examples, indirect-to-indirect path switching may be implemented.

In certain representative embodiments, methods, systems, apparatus, procedure, and/or operations may be implemented for the source UE to determine via which U2U relay its peer UE is reachable and/or to coordinate direct-to-indirect path switching with this peer UE.

### Representative Procedures for Seamless Continuity and IP Address Re-Use

Seamless continuity may be obtained by preserving the IP addresses used for a link between 2 peer UEs (e.g., the source and target UEs) and their re-use on the new link. The Application layer in this example does not need to be or may not be aware of the path switching. When re-using the same IP addresses with another indirect link or with a direct link: (1) if an IP address allocated by a Relay (RID1) is used with another Relay (RID2) after path switching, in certain representative embodiments, an IP address allocated by the Relay RID1 may not be released and/or may not be assigned or reassigned to another UE while in use with the other relay RID2; (2) if an IP address allocated by the Relay (RID1) is also allocated by the other Relay (RID2) to another UE, in certain representative embodiments, the Relay RID2 may determine to which UE the traffic is to be or may be routed if the same IP address is associated with two different UEs; and/or (3) if an IP address allocated by the Relay (RID1) is also allocated by the other Relay (RID2) to another UE, in certain representative embodiments, the IP address duplication may be handled at the Relay RID1 and/or at the Relay RID2.

The terms ProSe Application Layer ID, Application Layer ID of the UE, ProSe User Info, and User Info of the UE may be used interchangeably herein. The term IP address (sometimes also referred to as IP addr) and the term IP prefix may be used interchangeably herein and, for example, whenever an IP address is used herein, it may be replaced by IP prefix. The term “keep IP addr indication” and the term “reuse indication” may be used interchangeably herein.

For IP-based communication via the L3 Relay, multiple procedures may be implemented.

### Detail of Representative Procedures for Indirect-to-Direct Path Switching

For a source UE that knows/determines the user info of a target UE and the target UE does not know the user info of the source UE, the source UE may learn/determine an IP address of the target UE, for example by sending a DNS Query message to the Relay (e.g., associated with the indirect path). The DNS Query message may include the user info of the target UE (e.g., received from the application layer). The Relay may reply with a DNS Response message which includes the IP address of the target UE. The source UE and the target UE may communicate via the Relay.

In certain representative embodiments, for example in a first case (Case 1), the source UE may detect that the target UE is directly reachable after execution of a Discovery procedure. For example, the source UE may initiate a direct link establishment procedure and indirect-to-direct path switching by including indirect link info in a message (e.g., in a DCR message or in a DSM Complete message). The indirect link info may include any of: (1) one or more RIDs, (2) an IP addr of the source UE via a relay, (3) an IP addr of the target via the relay, (4) an App ID, and/or (5) user info of the target UE, among others.

In certain representative embodiments, for example in a second case (Case 2), the source UE does not know and/or may not determine that the target UE is directly reachable and may broadcast a message (e.g., a DCR message). The source UE may detect that the source UE currently has an indirect link with the target UE when receiving a DCA message for the direct link establishment, which may contain and/or may include the user info of the target UE. The source UE may initiate indirect-to-direct path switching, for example by sending an update message (e.g., an updated Link Modification Request message) or a new request (e.g., a new Link Switching Request) over/using the direct link, which may include/indicate the indirect link information.

In certain representative embodiments, for example in a third case (Case 3), the source UE and the target UE do not know and/or may not determine that they are directly reachable and the target UE may broadcast a message (e.g., a DCR message). The source UE may detect that the source UE currently has an indirect link with the target UE when receiving the DCR message, which may contain and/or may include the user info from the target UE. The source UE may initiate indirect-to-direct path switching, for example by including path switching info in a message (e.g., a DSM Command message).

For a source UE and a target UE that do not know/has not determined the user info of their peer UE, the source UE may learn/determine an IP address of the target UE, for example by sending a DNS Query message. The DNS Query message may include a ProSe Service and the Relay may reply with a DNS Response message including the IP address. After and/or upon receiving a DNS Query including a ProSe Service, the Relay may include the user info of the target UE in a DNS Response in addition to the IP address of the target UE. After the source UE receives the target UE user info and/or IP address, the first, second and third cases (Cases 1-3), above may then apply (e.g., may then be completed).

### Details of Representative Procedures for Direct-to-Indirect Path Switching

The source UE and target UE may negotiate which Relay to use for the indirect link. For any of: (1) the indirect-to-indirect path switching procedures and/or (2) the direct-to-indirect path switching procedures, the Relay for indirect communications may be or may need to be negotiated/selected. The IP addresses used via the selected relay may be exchanged during the path switching. In certain examples, the source and target UEs may decide/determine to keep/maintain the IP addresses used for, on and/or over the direct link and may re-use these IP addresses for, on, and/or over the indirect link. In this example, the IP address may be or may need to be registered with the selected Relay. The direct-to-indirect path switching may include any of the following:
(1) the source UE may decide/determine to switch the current direct communication to an indirect communication and/or to prepare for an imminent path switching;
(2) the source UE may send a request (e.g., a Link Modification Request or new Link Switching Request) with any of: (i) a direct-to-indirect indication, (ii) a list of candidate RIDs and/or (iii) a keep-IP-addr indication; (iv) if the request is to prepare for a path switching, e.g., the path switching is not done immediately, a “prepare” indication, and/or (v) a link quality threshold may be specified/included/indicated in the request;
(3) the target UE, for example receiving the request, may select the relay from the candidate RID list (for example, if the keep-IP-addr indication is included and if the target UE agrees to re-use the IP addr of the target UE of the direct link for and/or over the indirect link, the target UE may register this IP addr with the selected Relay. If the “prepare” indication is specified/included and/or indicated, the target UE may decide/determine to not register the IP addr of the target UE with the selected Relay at this point and to register the IP addr of the target UE when (e.g., only when) actually doing the path switching, e.g., when the link quality threshold, if provided, is met or when the direct link is lost;
(4) the target UE may send back a message (e.g., a Link Modification Accept message) including either the IP addr used in and/or over the direct link to reuse the IP address of the target UE (e.g., based on a keep-IP-addr indication) or the IP address used with (e.g., assigned by) the selected relay;
(5) the source UE may register the IP address of the source UE with the selected relay, if the IP addr from the direct link is re-used on the indirect link (and as for the target UE, if the Link Modification procedure is used to prepare for an imminent path switching, the source UE may decide/determine to not register the IP addr of the source UE with the Relay, at this point, and to register the IP addr of the source UE when (e.g., only when) actually doing the path switching (e.g., if the link quality threshold was provided on the Link Modification Request, when the link quality threshold is met or if the direct link is lost);
(6) the source UE may send a message (e.g., a Link Modification Ack message) including the IP addr of the source UE with the selected relay, if the IP addr used on the direct link is not re-used; and/or
(7) the source UE and/or the target UE may release the direct link once the traffic is switched over the indirect link, among others.

For path switching preparation, the path switching may be done immediately after completion of the Link Modification procedure, or after (e.g., only once) the threshold is met or the link is lost. For example, the source UE1 and/or the target UE2 may monitor the link quality of the direct link and may trigger the path switching, when the threshold is met. As another example, the source UE1 and/or the target UE2 may maintain the direct link and may continue to monitor the link quality of the direct link after the switch to the indirect link. If the direct link quality is improving, the path switching may be done from indirect link to the direct link without the need to establish a new direct link.

### Representative Procedures for Multiple Paths Support

Multiple paths may be used concurrently and/or simultaneously for additional bandwidth and/or for one or more backup links. The source UE and the target UE may negotiate/determine usage of one or more additional and/or backup links. For example, at any time, the source UE and/or the target UE may decide/determine to add a new link and/or remove an existing link: (1) to change the bandwidth (increase/decrease the bandwidth of a communication, (2) for one or more specific traffic transmissions and/or (3) as a backup. As for the indirect-to-indirect procedures, the addition of an indirect or direct communication may be or may need to be negotiated. For example, the source UE may decide/determine to switch the current direct communication to an indirect communication.

### Representative Operations for Indirect-to-Direct Path Switching

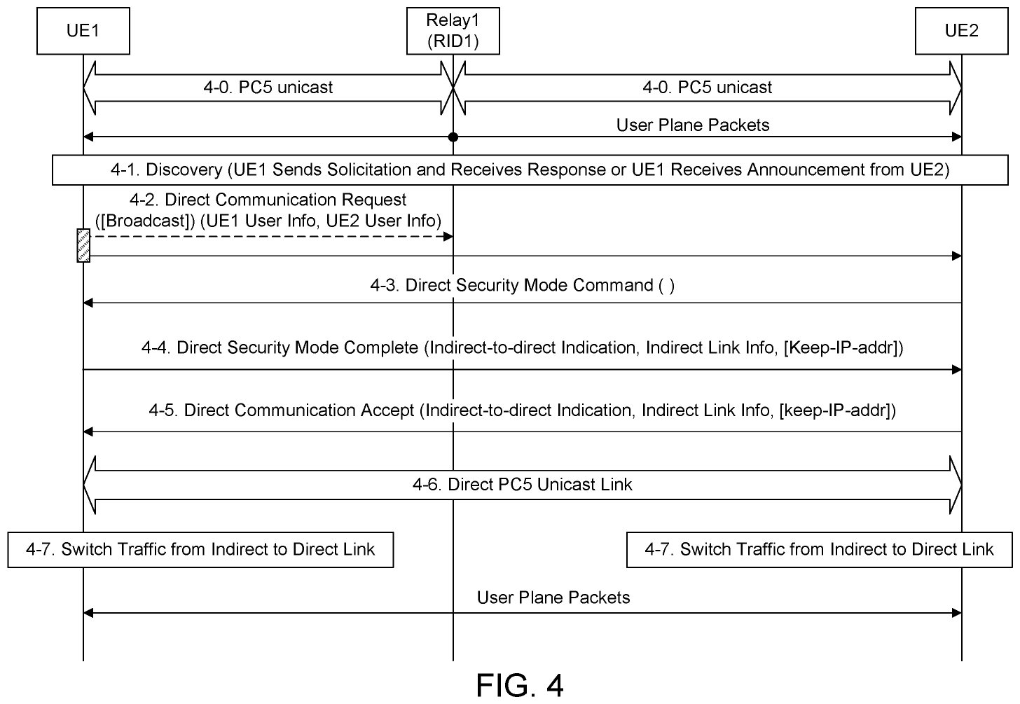

FIG. 4 is a diagram illustrating a representative indirect-to-direct path switching, according to an embodiment. For example, the indirect-to-direct path switching may be triggered during direct link establishment using a message (e.g., a DSM Complete message). The source UE may know/determine the user info of the target UE and the target UE may not know/determine the user info of the source UE. In a first example, a source UE1 may know/determine that a target UE2 is directly reachable after the Discovery procedure. This indirect-to-direct Path Switching (Case 1) may include any of:

Operation 4-0 in which the source UE1 and the target UE2 may have a PC5 unicast link established with the Relay (indirect link). The source UE1 may know/determine the user info of the target UE2 (received from e.g., the application layer). The source UE1 and the target UE2 may exchange IP traffic (e.g., user plane packets) via the Relay. The target UE2 does not know/has not determined the user info of the source UE1.

Operation 4-1 in which the source UE1 may discover that the target UE2 is directly reachable during a Discovery procedure (e.g., the source UE1 may send a message (e.g., a Solicitation message) and may receive a Response message and/or the source UE1 may receive another message (e.g., an Announcement message) from the target UE2. User info of the target UE2 discovered during the Discovery procedure is the same user info that is associated to an indirect link via the Relay.

Operation 4-2 in which the source UE1 may initiate a PC5 direct link establishment with target UE2 by sending a message (e.g., a DCR message) to the target UE2 (e.g., specifying/providing user info of the target UE2). The DCR message may be broadcasted and/or sent to L2 ID of the target UE2, as discovered in operation 4-1.

Operation 4-3 in which the target UE2 may send a message (e.g., a DSM Command message) to the source UE1. The target UE2 may not or does not know, at this point, that the source UE1 which has sent the DCR message is the same UE with which an indirect link already exists since the target UE2 does not know the user info of the source UE1.

Operation 4-4 in which the source UE1 may initiate an indirect-to-direct path switching by including path switching information in the DSM Complete message. The Path switching information may include any of: (1) an “indirect-to-direct” indication, (2) indirect link info and/or (3) a “keep-IP-addr” indication, among others. The Indirect link info may include any of: (1) a Relay identifier (RID), an IP addr (e.g., IP address) of the source UE1 via the relay, (2) the IP addr of the target UE2 via the relay, (3) the App ID, and/or (4) the user info of the target UE2. The “keep-IP-addr” indication (e.g., which may optionally be sent) may indicate that the IP addresses used to exchange traffic via the indirect link may be re-used or are re-used for the direct link, for example as disclosed herein and also regarding seamless continuity. Since the path switching information may be sent using the DSM Complete message, the path switching information may be sent with integrity and confidentiality protection, e.g., the path switching information may not be visible by other UEs except the target UE2 or tampered with by a malicious third party, as it is contemplated that integrity and confidentiality protection is enabled for this direct link.

Operation 4-5, in which the target UE2, which may receive path switching information in the DSM Complete message, may validate that the target UE2 has an ongoing indirect link with the source UE1 based on the received information. If the ongoing link is discovered/found and the target UE2 accepts the path switching, the target UE2 may reply by sending a DCA message including the path switching information as received at operation 4-4. For example, if the target UE2 accepts the path switching and does not accept to re-use the IP addresses from the indirect link, the target UE2 may include the path switching information without the “keep-IP-addr” indication. As another example, if the target UE2 does not accept the path switching and accepts to establish a PC5 direct unicast link, the DCA message may be sent without including the path switching information. In certain embodiments, if the target UE2 does not accept the path switching, the target UE2 does not or may not include the path switching information in the DCA message. If the target UE2 does not want/prefer/determine to establish a direct link, the target UE2 may send a Direct Communication Reject message to the source UE1 which may include a cause value (e.g., “path switching rejected”).

Operation 4-6, in which the source UE1 may receive the DCA message and/or may verify if the same IP addresses may or may not be re-used. If the same IP addresses are re-used, the IP addresses from the indirect link are associated with the direct link and the IP address allocation procedure may be skipped. Otherwise, the IP address allocation procedure may be executed as usual. A direct PC5 unicast link may be established between the source UE1 and the target UE2, in addition to the existing indirect link via the relay.

Operation 4-7, in which the source UE1 and the target UE2 may switch traffic from an indirect link to a direct link, e.g., the source UE1 and the target UE2 may send traffic over the direct link and may receive traffic over the direct link.

### Representative Procedures Using Path Switching Triggered Using a DCR Message

The source UE1 may trigger path switching using the DCR message via operation 4-2 instead of the DSM Complete message. In this case, the path switching information may be sent using the DCR message. The path switching information may be sent unprotected, for example as clear text. If the target UE2 accepts the path switching, the target UE2 may resend the same path switching information with integrity protection in the DSM Command message. In certain examples, if the target UE2 does not want/prefer or does not determine to switch the indirect link to the new direct link, the target UE2 may reply with a DSM Command message without including the path switching information. The target UE2 may, instead, reject the direct link establishment, for example by sending a message (e.g., a DSM Reject message) with a cause value (e.g., “path switching rejected”).

### Representative Procedures for Capability Exchanged Using DCR/DCA Messages and Path Switching Triggered Using Link Modification Procedure

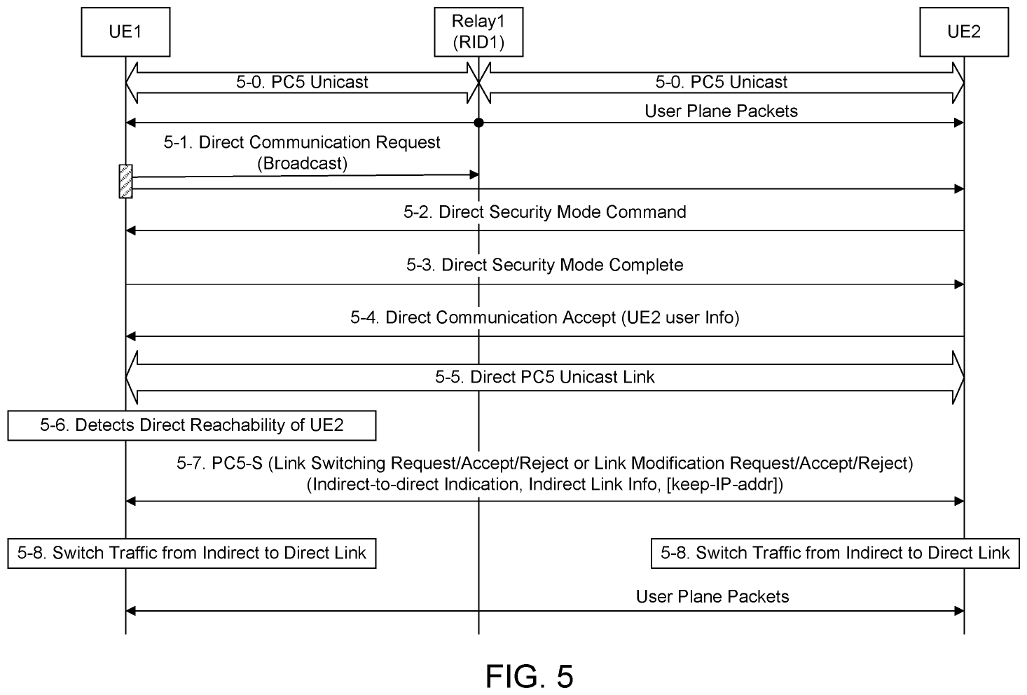

Capabilities may be exchanged during the link establishment procedure. In this case, the source UE1 may decide to trigger path switching based on the capabilities of the peer UE (e.g., the target UE2) using the Link Modification procedure (or Link Switching procedure), as set forth herein and, for example with regard to FIG. 5. and operation 5-7.

FIG. 5 is a diagram illustrating a representative indirect-to-direct Path Switching, for example triggered after direct link establishment using a PC5 signaling message.

Referring to FIG. 5, the source UE1 does not or may not know/determine that the target UE2 is directly reachable and may broadcast a DCR message. For Case 2 indirect-to-direct Path Switching any of the following operations may occur:
(1) Operation 5-0, in which any of the operations associated with FIG. 4 (Case 1) may occur;
(2) Operation 5-1, in which the source UE1 may broadcast a message (e.g., a DCR message) without specifying/determining any user info of the target UE2. The source UE1 may advertise one or more supported ProSe services;
(3) Operation 5-2, in which the target UE2 may trigger the Direct Security Mode procedure, for example by sending a message (e.g., a DSM Command message), for example as usual. The target UE2 does not or may not know/determine the user info of the source UE1 and/or the target UE2 may not or cannot detect that an indirect link exists with the source UE1;
(4) Operation 5-3, in which the source UE1 may complete the procedure, for example by sending a complete message (e.g., a DSM Complete message), for example as usual;
(5) Operation 5-4, in which the target UE2 may complete the direct link establishment, for example by sending a DCA message, which may include or indicate the user info of the target UE2, for example as usual;
(6) Operation 5-5, in which a direct link is established between the source UE1 and the target UE2.
(7) Operation 5-6, in which, upon receiving the DCA message, the source UE1 may detect direct reachability of the target UE2 and/or the source UE1 currently may have an indirect link with the source UE2 in addition to the newly established direct link;
(8) Operation 5-7, in which the source UE1 may initiate indirect-to-direct path switching, for example by sending a message (e.g., a modified Link Modification Request message) or a request (e.g., a new Link Switching Request) in and/or over the direct link. This message or request may include indirect link information. Another message may be sent and may include direct link information in and/or over the indirect link. These messages may also include path switching information as described herein and for example, regarding FIG. 4 (Case 1) and operation 4-4. For example, the source UE1 may send a Link Modification Request message including the path switching information. The target UE2 may reply with a Link Modification Accept message, if the target UE2 accepts the path switching. The target UE2 may accept path switching and may accept or reject to re-use the IP addresses from the indirect link. The target UE2 may also reject the path switching, for example by sending a Link Modification Reject message. If the “keep-IP-addr” indication (e.g., a reuse indication) is included and accepted (via the Link Modification Accept message), the direct link may be associated with the IP addresses used for the indirect link. In this case, no new IP addresses may be or are assigned after the direct link establishment procedure completion; and/or
(9) the source UE1 and the target UE2 may send and/or may receive traffic over the direct link, instead of using the indirect link, among others.

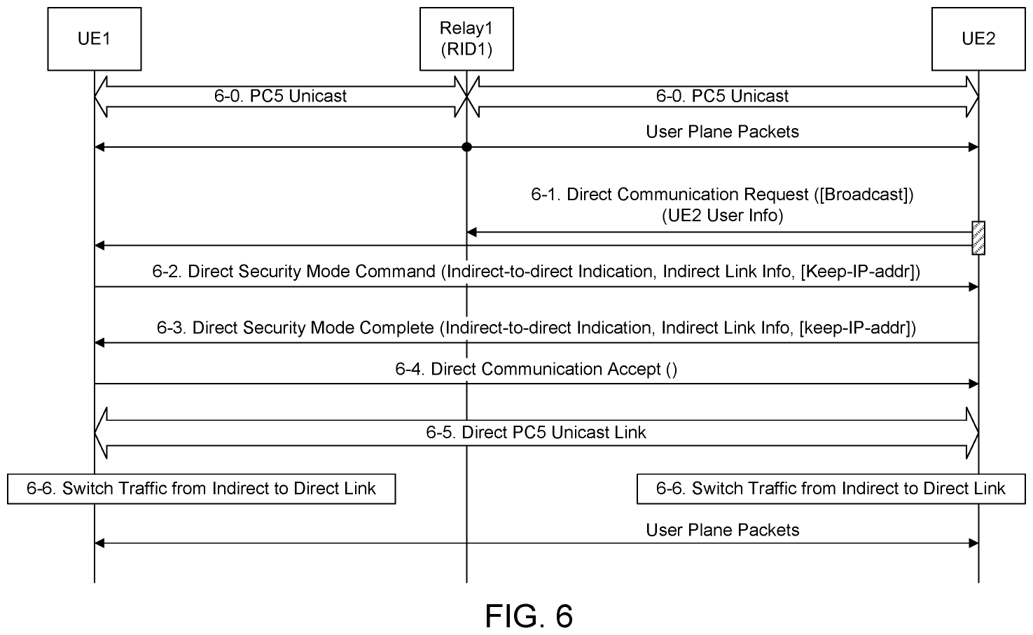

FIG. 6 is a diagram illustrating a representative indirect-to-direct Path Switching triggered during direct link establishment using a DSM Command message.

Referring to FIG. 6, the target UE2 does not or may not know/determine that the source UE1 is directly reachable and may broadcast a DCR message. For Case 3 indirect-to-direct Path Switching any of the following operations may occur:
(1) Operation 6-0, in which any of the operations associated with FIG. 4 (Case 1) may occur;
(2) Operation 6-1, in which the target UE2 may broadcast a message (e.g., a DCR message) without specifying/determining any user info of the target UE2. The target UE2 may advertise one or more supported ProSe services;
(3) Operation 6-2, in which the source UE1 may detect that the source UE1 currently has an indirect link with the target UE2 when receiving the message (e.g., DCR message). The DCR message may include the user info of the target UE2, for example as usual. The source UE1 may initiate indirect-to-direct path switching, for example by including path switching info in a DSM Command message. The path switching info is disclosed herein and for example with regard to FIG. 4 (Case 1) and operation 4-4;
(4) Operation 6-3, in which the target UE2, receiving the path switching information in the DSM Command message, may validate that the target UE2 has (e.g., really has) an ongoing indirect link with the source UE1 based on the received information. For example, if the ongoing link is found and the target UE2 accepts the path switching, the target UE2 may reply, for example by sending a message (e.g., a DSM Complete message) including the path switching information with integrity protection, for example as received at operation 6-2. For example, if the target UE2 accepts the path switching and does not accept to re-use the IP addresses from the indirect link, the target UE2 may include the path switching information without the “keep-IP-addr” or reuse indication. As another example, if the target UE2 does not accept the path switching and accepts to establish a PC5 direct unicast link, the DSM Complete message may be sent without including the path switching information. As a further example, if the target UE2 does not want/prefer/determine to establish a direct link, the target UE2 may send a Direct Communication Reject message to the source UE1 and may include a cause value (e.g., “path switching rejected” cause value) indicating that the path switch was rejected;
(5) Operation 6-4, in which the source UE1 may send the DCA message and may verify, if the same IP addresses are or are not to be re-used. If the IP addresses are to be re-used, the IP addresses from the indirect link may be associated with the direct link. Otherwise, the IP address allocation procedure is executed, for example as usual, after the link establishment procedure is completed;
(6) Operation 6-5 in which a direct PC5 unicast link may be established between the source UE1 and the target UE2, in addition to the existing indirect link via the relay; and/or
(7) Operation 6-6, in which the source UE1 and the target UE2 may switch traffic from the indirect link to the direct link, (e.g., the source UE1 and/or the target UE2 may send traffic to the direct link and/or receive traffic from the direct link.

### Representative Procedure for Direct-to-Indirect Path Switching

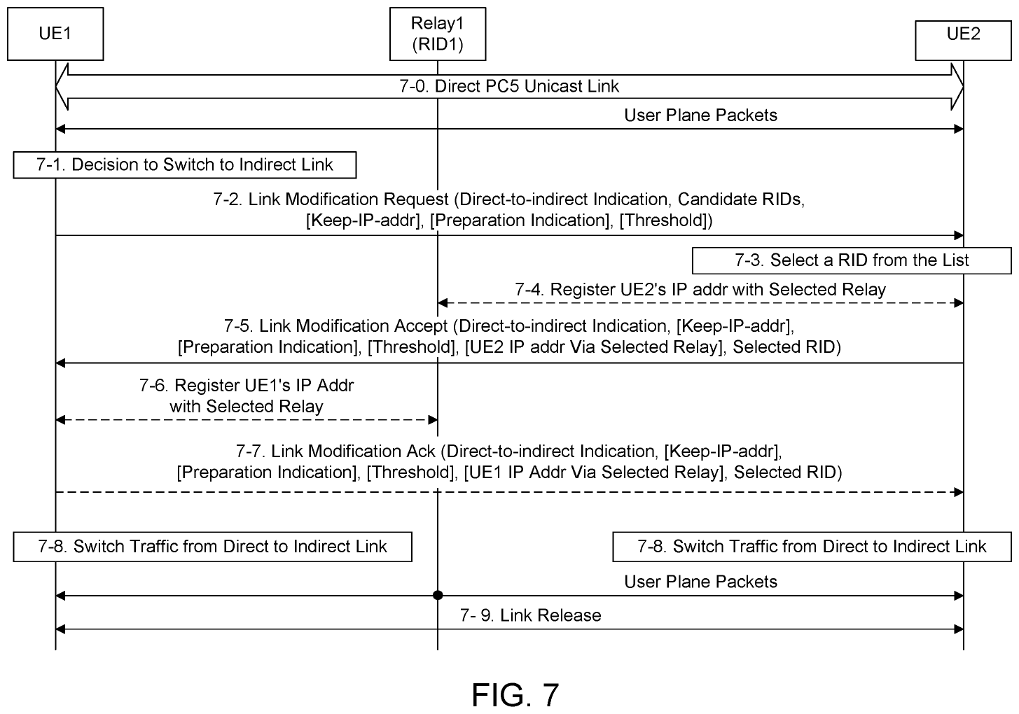

FIG. 7 is a diagram illustrating a representative direct-to-indirect Path Switching.

Referring to FIG. 7, the representative direct-to-indirect path switching may include any of the following operations:
(1) Operation 7-0, in which the source UE1 may have a PC5 unicast link established with the Relay RID1. The target UE2 may have a PC5 unicast link established with the Relay RID1. The source UE1 and the target UE2 may communicate via a direct PC5 unicast link. The source UE1 and the target UE2 may know their peer user info.
(2) Operation 7-1, in which the source UE1 may determine (e.g., take the decision) to switch the traffic with the target UE2 to and/or via an indirect link. This determination/decision may be based on various factors including for example any of: (1) direct link quality; (2) direct link quality degradation; and/or (3), policies, among others.
(3) Operation 7-2, in which the source UE1 may initiate a direct-to-indirect path switching, for example by sending a message (e.g., a Link Modification Request message) using the direct link. The message may include path switching information for Relay selection. The path switching information may include any of: (1) a “direct-to-indirect” indication; (2) a “keep-IP-addr” (reuse) indication, (3) a “preparation” indication; (4) one or more thresholds (e.g., including a preparation threshold); and/or (5) a candidate list of RIDs. The “keep-IP-addr” indication may indicate that the IP addresses used to exchange traffic via the direct link are re-used for the indirect link, as described herein and for example with regard to seamless continuity. The “preparation” indication may indicate that the path switching is to be prepared (e.g., the Relay selected), but the path switching is not to be done immediately after the Link modification procedure completion. The one or more thresholds may be for the link quality and may be specified. This threshold, when met, may trigger the path switching to the indirect link with the selected Relay. The threshold may indicate, for example a LOW threshold and/or a HIGH threshold. A link quality not meeting (e.g., below) the LOW threshold may indicate that the link quality is bad using the direct link and that path switching to an indirect link should be or is to be done. A link quality meeting (e.g., above) the HIGH threshold may indicate that link quality is good using the direct link and that path switching from an indirect link to a direct link should be, may be or is to be done.
(4) Operation 7-3, in which the target UE2 may select a Relay based on the received list of candidates RIDs. The target UE2 may decide/determine if the IP addresses used for the direct link are re-used for the indirect link via the Relay, for example based on reception of an indication (e.g., the “keep-IP-addr” (e.g., reuse indication).
(5) Operation 7-4, in which the target UE2 may register the IP address of the target UE2 with the selected Relay (e.g., if the IP address is not already registered). For example, such a registration may occur, if the IP addresses from the direct link are re-used for the indirect link via the selected Relay. The target UE2 may decide/determine to not register the IP address of the target UE2 at this point and may wait for the path switching trigger (e.g., a threshold to be met, or the direct link is lost) to complete the registration operation.
(6) Operation 7-5, in which the target UE2 may send a message (e.g., a Link Modification Accept message) to the source UE1 via the direct link, if the target UE2 accepts the path switching. As described herein and for example as set forth in FIG. 4, the target UE2 may accept path switching and reject to re-use the IP addresses from the direct link. The target UE2 may reject the path switching, for example by sending a reject message (e.g., a Link Modification Reject message). For example, if the “keep-IP-addr” (e.g., reuse) indication is specified/included and accepted, the indirect link may be associated with the IP addresses used for the direct link. In this case, no new IP addresses may be or are to be assigned during and/or after the indirect link establishment procedure. As another example, if the target UE2 does not accept to re-use the IP address from the direct link, the “keep-IP-addr” indication may not be specified/included in the Link Modification Accept message. Instead, the IP address of the target UE2 used for the selected Relay may be specified/included in the Link Modification Accept message.
(7) Operation 7-6, in which the source UE1 may register the IP address of the source UE1 with the selected Relay (e.g., having an RID) as received in operation 7-5, if the decision/determination is to re-use the IP address from the direct link and the IP address of the source UE1 is not already registered. The source UE1 may decide/determine to not register the source IP address at this point and may wait for the path switching trigger (e.g., wait until a threshold is met, or the direct link is lost) to register the IP address of the source UE1.
(8) Operation 7-7, in which the source UE1 may send an acknowledgment message (e.g., a Link Modification Ack message) to the target UE2 over/using the direct link. This operation is used/needed if the source/target UEs do not keep/maintain the same IP addresses from the direct link to the indirect link. In this case, the IP address of the source UE1 known at the selected Relay may be sent to the target UE2 using this acknowledgement message. In certain embodiments, operations 7-4 and 7-7 may be replaced by one or more DNS Queries from the source UE1 and/or the target UE2. The acknowledgement message (e.g., the Link Modification Ack message) may include any of: (1) a “keep IP addr” indication, if agreed to/negotiated, (2) if the “keep IP addr” indication is not specified/included in the acknowledgment message, the IP address of the source UE1 used with the selected Relay (e.g., RID) may be provided, and/or (3) a preparation indication and/or threshold, for example if specified in the request message at operation 7-2.
(9) Operation 7-8, in which after the path switching, the source UE1 and the target UE2 may send and/or may receive traffic over the indirect link, instead of using the direct link, transparently to the Application layer, if the IP addresses from the direct link are re-used. For example, the path switching may be done immediately after completion of the Link Modification procedure, if the “preparation” indication is not specified/included in the acknowledgment message. If the “preparation” indication is specified/included with a threshold value, the source UE1 and/or the target UE2 may monitor the link quality of the direct link and may trigger the path switching when the threshold value is met, (e.g., when the link quality does not satisfy the LOW threshold such that data may be sent via the indirect link). If a HIGH threshold is specified/included in the acknowledgment message, the source UE1 and/or the target UE2 may continue monitoring the link quality of the direct link after the switch to the indirect link and if the direct link quality is improving, e.g., meets/satisfies the HIGH threshold, the path switching may be done from the indirect link to the direct link. The thresholds may be monitored at the ProSe layer based on measurements received from one or more lower layers. In certain embodiments, the ProSe layer may configure the lower layers with the thresholds (e.g., threshold values) and/or the lower layers may indicate to the ProSe layer when a threshold is met, triggering the path switching from the direct link to the indirect link or vice-versa. If the “preparation” indication is specified/included without a threshold value, the source UE1 and the target UE2 may trigger the path switching when the direct link is lost. If the “preparation” indication is specified/included, the source UE1 and/or the target UE2 may re-run the Link Modification procedure periodically and/or may select another relay for path switching, based on the candidate list of RIDs at this point for the source UE1 and/or the target UE2.
(10) Operation 7-9, in which the direct link may be released or may be kept (e.g., maintained) to enable a switch back (e.g., to enable faster resumption) from the indirect link to the direct link. As described herein, if a HIGH threshold is specified/included, the direct link may be re-used.

It is noted that, in certain embodiments, the diagrams illustrated in FIGS. 2-7 and/or operations depicted therein may be combined in any suitable manner.

### Representative Procedures for Multiple Paths Support

Multiple links may be used simultaneously between 2 peers UEs, e.g., source UE1 and target UE2, for example a direct PC5 link and an indirect PC5 link via a Relay, or a 2 or more indirect links via 2 or more different Relays. The source UE1 may indicate which “type” of direct or indirect links, the source UE1 wishes/prefers to establish when sending e.g., the DCR message or the DSM Complete message. The target UE2 may accept the proposal/indication or may decide/determine otherwise, for example by sending another type or other corresponding indication.

The new link “type” indication may include any of: (1) an “indirect-to-direct” indication, when switching traffic from an indirect link via a Relay to a direct link; (2) a “direct-to-indirect” indication, when switching traffic from a direct link to an indirect link via a Relay; (3) a “direct+indirect” indication, when associating (e.g., adding) a new direct link with an existing indirect link; and/or (4) an “indirect+direct” indication, when associating (e.g., adding) a new indirect link with an existing direct link.

For multiple path support with an “direct+indirect” indication or a “indirect+direct” indication, another new “usage” field may be included to specify the usage of this new link. The new “usage” field values may indicate, for example any of: (1) additional bandwidth; (2) signaling traffic (e.g., signaling traffic only); (3) data traffic (e.g., data traffic only); and/or (4) backup.

### Representative Procedures for Seamless Continuity

Seamless continuity may be obtained by preserving the IP addresses used for a link between 2 peer UEs and their re-use on the new link. The Application layer in this case does not need to be aware of the path switching.

To be able to support this re-use of IP addresses from a link to another link, the UEs manage for themselves the IP addresses, i.e. instead of the Relay. This enables the UEs to establish a direct link and then to switch their communication using the same IP addresses over an indirect link, or to establish an indirect link and then move to another indirect link or to a direct link, still using the same IP addresses.

The UEs may register their IP address, and corresponding Application ID and/or user info, with the Relay when switching to an indirect link. The registration may be done (1) during the indirect link establishment procedure or (2) after the indirect link establishment. During the link establishment, the UE may indicate to the Relay that the UE already has an IP address using the DSM Complete message and including this IP address in the DSM Complete message. For example, the IP address configuration IE may be set to a new value e.g., “address allocation not needed”. In this case, the Relay provides its own IP address in the DCA message. No further IP allocation procedure is used or may be needed to be executed after the link establishment. In certain embodiments, the UE may act as the DHCP server or a IPv6 router and may allocate an IP address to the Relay. In this case, the UE may re-use the IP address of the UE and may assign a new IP address to the Relay. If a link is already established with the selected Relay prior to the path switching, the UE may register with the Relay the IP address that the UE is using for the link to be switched. This may be done, e.g., using Link Modification Request message including the IP address to be registered. In this case, the Relay may add the association of this IP address with the user info of the UE and Application ID (e.g., in the DNS entries of the Relay).

When switching to a direct link, the first and second UEs may use the “keep IP addr” indication (as described herein and for example as shown in FIGS. 4 and 6) in the DSM Complete/DCA messages. The UEs may agree to re-use the same IP addresses. If the UEs agree, the IP address configuration information element (IE) and the link local IPv6 address IE may not be specified in the DSM Complete/DCA messages. In certain examples, the IP address configuration IE may be set to a new value (e.g., “address allocation not needed”). The first and second UEs may be provisioned with a pool of IP addresses (IPv4 prefixes and/or IPv6 prefixes) that are unique, for example to avoid having more than one UE registering the same IP address with a Relay.

### Representative Procedures for Path Switching Capabilities Exchange

The first and/or second UEs (e.g., UE1 and/or UE2) may indicate if the first and second UEs support: (1) path switching, (2) multiple paths and/or (3) seamless continuity on the Discovery messages. For example, an indication may be added to the Solicitation message indicating “path switching enabled”. The same indication may be specified/used in the Response message. An indication for multiple path support and/or another indication for seamless continuity support may be included and/or added in addition to or in lieu of the support for path switching indication. The support for path switching indication may be protected/verified in the Discovery messages using discovery keys obtained from a network function and/or an application function (e.g., DDNMF/PKMF) by the first and/or second UEs (e.g., UE1 and UE2).

In certain examples, capabilities may be exchanged during the link establishment procedure, e.g., the first UE (e.g., UE1) may send a message (e.g., a DCR message) including its capabilities. The second UE (e.g., the UE2) may replay the first UE1 capabilities with integrity protection during the DSM, for example to mitigate potential man in the middle (MiTM) attacks. The second UE2 may send its own capabilities on another message (e.g., a DCA message).

In other examples, the first UE1 may include its capabilities in the message DCR message and the Relay may save the first UE's (e.g., the UE1) capabilities, for example locally. When the Relay receives a DNS Query message about the first UE1 (e.g., from the second UE2), the Relay may reply with a Response message (e.g., a DNS Response message) which may include the first UE's (e.g., UE1's) capabilities.

### Representative Procedures for Provisioning

Path switching capability may be enabled/disabled via provisioning. Multiple paths and seamless continuity support may be provisioned on the UE. The UE may receive provisioning information (e.g., from a network entity), for example from the PCF, which may include information indicating any of e.g.: (1) an indirect-to-direct path switching being enabled or disabled; (2) a direct-to-indirect path switching being enabled or disabled; (3) an indirect-to-indirect path switching being enabled or disabled; (4) multiple paths support being enabled or disabled; and/or (5) seamless continuity being enabled or disabled.

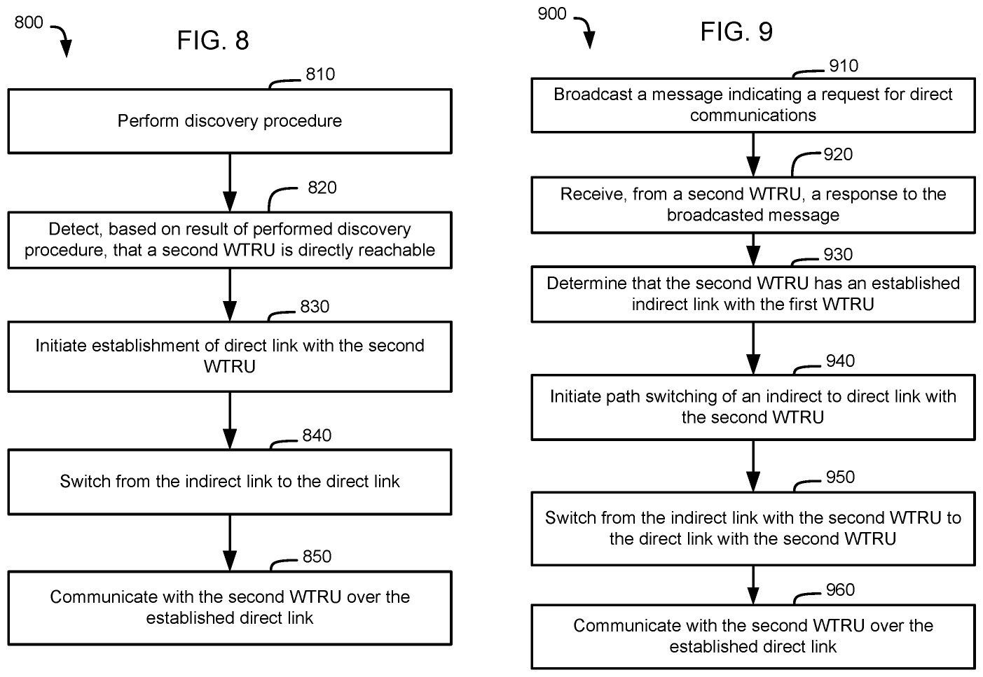

FIG. 8 is a flowchart illustrating a representative method 800 that may be implemented by a first WTRU having established an indirect link with a second WTRU, according to some example embodiments. For example, the first WTRU may have established an indirect link with the second WTRU via a relay. Referring to FIG. 8, the representative method 800 may include, at 810, the first WTRU performing a Discovery procedure. At 820, the first WTRU may detect, based on a result of the performed Discovery procedure, that the second WTRU is directly reachable. For example, in one embodiment, the first WTRU may detect at 820 that the second WTRU may be directly reachable via a direct link (i.e., not going through a relay). At 830, the first WTRU may initiate establishment of a direct link with the second WTRU. According to an embodiment, the direct link may be a PC5 direct link or PC5 unicast link.

In the example of FIG. 8, at 840, the first WTRU may switch from the indirect link to the direct link. According to an embodiment, the switching 840 from the indirect link to the direct link may include initiating an indirect-to-direct path switch by sending a message, to the second WTRU, including or indicating indirect link information. The indirect link information may include one or more of: (1) one or more relay identifiers associated with the indirect link, (2) an IP address of the first WTRU, (3) an IP address of the second WTRU, (4) an application identifier, and/or (5) user information of the second WTRU. According to an embodiment, the user information of the second WTRU may include information used to uniquely identify a user for a specific application (e.g., a unique user name). In certain embodiments, the message may be a Direct Communication Request (DCR) message or a Direct Security Mode (DSM) Complete message. According to an embodiment, the message may include information that includes one or more of: (1) an indication indicating a type of path switch, and/or (2) a reuse indication indicating a preference by the first WTRU that IP addresses of the first and second WTRUs used for the indirect link be reused for the direct link.

As illustrated in the example of FIG. 8, at 850, the first WTRU may communicate, with the second WTRU, over the established direct link after the switch. In some embodiments, the representative method 800 may further include the first WTRU receiving an acceptance message including information confirming that the IP addresses of the first and second WTRUs used for the indirect link are to be reused for the direct link. According to certain embodiments, the representative method 800 may include the first WTRU receiving information indicating whether to switch to the direct link based on a triggering condition being satisfied, determining whether the triggering condition is satisfied, and triggering the switching from the indirect link to the direct link based on the triggering condition being satisfied.

FIG. 9 is a flowchart illustrating a representative method 900 that may be implemented by a first WTRU, according to some embodiments. Referring to FIG. 9, the representative method 900 may include, at 910, the first WTRU broadcasting a message indicating a request for direct communications. At 920, the first WTRU may receive, from a second WTRU, a response to the broadcasted message. At 930, the first WTRU may determine that the second WTRU has an established indirect link with the first WTRU.

In an embodiment, the receiving 920 of the response to the broadcasted message may include receiving from the second WTRU, an acceptance message indicating acceptance of direct communication with the first WTRU and information associated with the second WTRU. According to an embodiment, the determining 930 that the second WTRU has an established indirect link with the first WTRU may include determining that the received information associated with the second WTRU matches information associated with the established indirect link with the second WTRU. In some embodiments, the broadcasted message may be a Direct Communication Request (DCR) message and the response to the broadcasted message may be a Direct Communication Accept (DCA) message.

As further illustrated in the representative method 900 of FIG. 9, at 940, the first WTRU may initiate path switching of an indirect-to-direct link with the second WTRU. At 950, the first WTRU may switch from the indirect link with the second WTRU to the direct link with the second WTRU. In some embodiments, the switching 950 from the indirect link with the second WTRU to the direct link with the second WTRU may include initiating an indirect-to-direct path switch by sending, to the second WTRU, one or more of: (1) an update message using the established indirect link that includes information indicating direct link information, and/or (2) a request message using the direct link that includes information indicating indirect link information.

According to an embodiment, the update message may be a Link Modification Request message and/or the request message may be a Link Switching Request message. According to an embodiment, the switching 950 from the indirect link with the second WTRU to the direct link with the second WTRU may include initiating an indirect-to-direct path switch by sending, to the second WTRU in a Link Modification Request or Path Switching Request message, path switching information.

At 960, the representative method 900 may include communicating, by the first WTRU with the second WTRU over the established direct link after the switch.

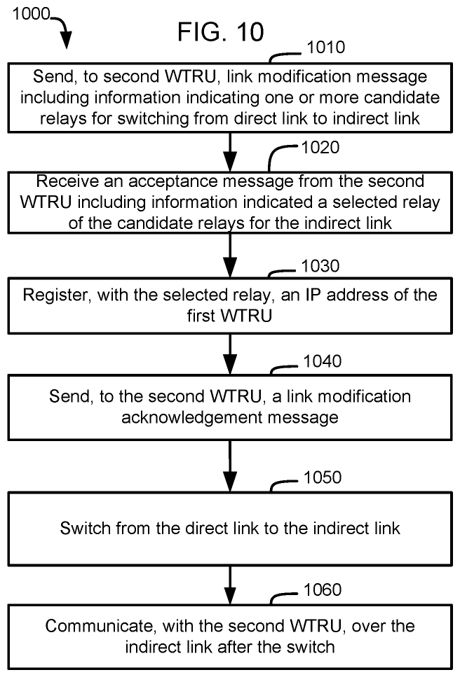

FIG. 10 is a flowchart illustrating a representative method 1000 that may be implemented by a first WTRU that has established a direct link with a second WTRU, according to some embodiments. Referring to FIG. 10, the representative method 1000 may include, at 1010, the first WTRU sending, to the second WTRU, a link modification message including information indicating one or more candidate relays for switching from the direct link to an indirect link. In some embodiments, the information in the link modification message may further indicate one or more of: (1) a type of link modification, (2) whether to reuse the direct IP addresses of the first and second WTRUs for the indirect link, and/or (3) whether to switch to the indirect link immediately or based on a triggering condition being met.

As further illustrated in the example of FIG. 10, at 1020, the representative method 1000 may include the first WTRU receiving an acceptance message from the second WTRU including information indicating a selected relay of the one or more candidate relays for the indirect link. The representative method 1000 may include, at 1030, registering, with the selected relay, an IP address of the first WTRU.

In some embodiments, the information in the acceptance message may further indicate reuse of the direct IP addresses of the first and second WTRUs for the indirect link and to switch to the indirect link based on a triggering condition being met. According to an embodiment, the registering 1030, with the selected relay, of the IP address of the first WTRU includes registering a same IP address of the first WTRU for the indirect link as the IP address of the first WTRU for the established direct link, after the triggering condition is met.

In some embodiments, the information in the acceptance message may further indicate reuse of the direct IP addresses of the first and second WTRUs for the indirect link and to switch to the indirect link immediately. According to an embodiment, the registering 1030, with the selected relay, of the IP address of the first WTRU includes registering a same IP address of the first WTRU for the indirect link as the IP address of the first WTRU for the established direct link, responsive to the acceptance message being received.

Referring again to FIG. 10, at 1040, the representative method 1000 may include the first WTRU sending, to the second WTRU, a link modification acknowledgement message. At 1050, the method 1000 may include switching from the direct link to the indirect link and, at 1060, communicating, with the second WTRU, over the indirect link after the switch. In some embodiments, although not depicted in the example of FIG. 10, the representative method 1000 may include determining whether to switch from communications with the second WTRU using the direct link to communications with the second WTRU using the indirect link.

It is noted that, in certain embodiments, the flow charts illustrated in FIGS. 8-10 and/or the operations depicted therein may be combined in any suitable manner.

Each of the contents of the following references is incorporated by reference herein in its entirety: (1) 3GPP TR 23.752 v.1.0, “Study on system enhancement for Proximity based Services (ProSe) in the 5G System (5GS) (Release 17)”; (2) 3GPP TDoc S2-2006575, entitled “KI #4, New Sol: Negotiated UE-to-UE Relay Reselection”; (3) 3GPP TDoc S2-2007736, entitled “KI #4, Sol #50: Update to add more details to UE-to-UE Relay Re-selection”; and (4) 3GPP TDoc S3-202706, entitled “Modification of KI for TR 33.847—security for UE2UE Relay path switch”.

Systems and methods for processing data according to representative embodiments may be performed by one or more processors executing sequences of instructions contained in a memory device. Such instructions may be read into the memory device from other computer-readable mediums such as secondary data storage device(s). Execution of the sequences of instructions contained in the memory device causes the processor to operate, for example, as described above. In alternative embodiments, hard-wire circuitry may be used in place of or in combination with software instructions to implement the present invention. Such software may run on a processor which is housed within a robotic assistance/apparatus (RAA) and/or another mobile device remotely. In the later a case, data may be transferred via wireline or wirelessly between the RAA or other mobile device containing the sensors and the remote device containing the processor which runs the software which performs the scale estimation and compensation as described above. According to other representative embodiments, some of the processing described above with respect to localization may be performed in the device containing the sensors/cameras, while the remainder of the processing may be performed in a second device after receipt of the partially processed data from the device containing the sensors/cameras.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer readable medium for execution by a computer or processor. Examples of non-transitory computer-readable storage media include, but are not limited to, a read only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU 102, UE, terminal, base station, RNC, or any host computer.

Moreover, in the embodiments described above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the representative embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (“RAM”)) or non-volatile (e.g., Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It is understood that the representative embodiments are not limited to the above-mentioned memories and that other platforms and memories may support the described methods. It should be understood that the representative embodiments are not limited to the above-mentioned platforms or CPUs and that other platforms and CPUs may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost vs. efficiency tradeoffs. There may be various vehicles by which processes and/or systems and/or other technologies described herein may be affected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

It is also to be understood that the terminology used herein is for the purpose of describing particular embodiments only, and is not intended to be limiting. As used herein, when referred to herein, the terms “station” and its abbreviation “STA”, “user equipment” and its abbreviation “UE” may mean (i) a wireless transmit and/or receive unit (WTRU), such as described infra; (ii) any of a number of embodiments of a WTRU, such as described infra; (iii) a wireless-capable and/or wired-capable (e.g., tetherable) device configured with, inter alia, some or all structures and functionality of a WTRU, such as described infra; (iii) a wireless-capable and/or wired-capable device configured with less than all structures and functionality of a WTRU, such as described infra; or (iv) the like. Details of an example WTRU, which may be representative of any UE recited herein, are provided below with respect to FIGS. 1A-1D.

In certain representative embodiments, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

The herein described subject matter sometimes illustrates different components contained within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mate-able and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of” multiples of the items and/or the categories of items, individually or in conjunction with other items and/or other categories of items. Moreover, as used herein, the term “set” or “group” is intended to include any number of items, including zero. Additionally, as used herein, the term “number” is intended to include any number, including zero.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

A processor in association with software may be used to implement a radio frequency transceiver for use in a wireless transmit receive unit (WTRU), user equipment (UE), terminal, base station, Mobility Management Entity (MME) or Evolved Packet Core (EPC), or any host computer. The WTRU may be used m conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

Throughout the disclosure, one of skill understands that certain representative embodiments may be used in the alternative or in combination with other representative embodiments.

In addition, the methods described herein may be implemented in a computer program, software, or firmware incorporated in a computer readable storage medium as instructions for execution by a computer or processor to perform the actions described hereinabove. Examples of non-transitory computer-readable storage media include, but are not limited to, a read only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method implemented by a first Wireless Transmit/Receive Unit (WTRU), the method comprising:
performing a discovery procedure,
detecting, based on a result of the performed discovery procedure, that a second WTRU is directly reachable;
initiating, following an established indirect link with the second WTRU, establishment of a PC5 direct link with the second WTRU;
switching from the indirect link to the PC5 direct link, wherein the switching from the indirect link to the PC5 direct link includes initiating an indirect-to-direct path switch including sending a message comprising indirect link information; and
communicating, by the first WTRU with the second WTRU, over the established PC5 direct link after the path switch.

2. The method of claim 1, wherein the indirect link information includes any of: (1) one or more relay identifiers associated with the indirect link; (2) an internet protocol address of the first WTRU; (3) an internet protocol address of the second WTRU; (4) an application identifier; and (5) user information of the second WTRU.

3. The method of claim 1, wherein the message comprises a direct communication request message or a direct security mode complete message.

4. The method of claim 1, wherein the message includes information indicating a preference by the first WTRU that internet protocol addresses of the first and second WTRUs used for the indirect link be reused for the PC5 direct link.

5. The method of claim 4, further comprising receiving an acceptance message including information confirming that the internet protocol addresses of the first and second WTRUs used for the indirect link are to be reused for the PC5 direct link.

6. The method of claim 1, further comprising:
receiving information indicating whether to switch to the PC5 direct link based on a triggering condition being satisfied;
determining whether the triggering condition is satisfied; and
triggering the switching from the indirect link to the PC5 direct link based on the triggering condition being satisfied.

7. The method of claim 1, further comprising:
sending a domain name system query message including information indicating a proximity-based service (ProSe) for indirect links; and
receiving a domain name system response message including the internet protocol address and the user information of the second WTRU.

8. A first Wireless Transmit/Receive Unit (WTRU), comprising:
a processor configured to:
perform a discovery procedure;
detect, based on a result of the performed discovery procedure, that a second WTRU is directly reachable;
initiate, following an established indirect link with the second WTRU, establishment of a PC5 direct link with the second WTRU; and
switch from the indirect link to the PC5 direct link, wherein the switching from the indirect link to the PC5 direct link includes initiating an indirect-to-direct path switch including sending a message comprising indirect link information; and
a transmitter/receiver configured to:
communicate, with the second WTRU, over the established PC5 direct link after the path switch.

9. The WTRU of claim 8, wherein the indirect link information includes any of: (1) one or more relay identifiers associated with the indirect link; (2) an internet protocol address of the first WTRU; (3) an internet protocol address of the second WTRU; (4) an application identifier; and (5) user information of the second WTRU.

10. The WTRU of claim 8, wherein the message comprises a direct communication request message or a direct security mode complete message.

11. The WTRU of claim 8, wherein the message includes information indicating a preference by the first WTRU that IP addresses of the first and second WTRUs used for the indirect link be reused for the direct link.

12. The WTRU of claim 11, wherein the transmitter/receiver is configured to:
receive an acceptance message including information confirming that the internet protocol addresses of the first and second WTRUs used for the indirect link are to be reused for the PC5 direct link.

13. The WTRU of claim 8, wherein:
the transmitter/receiver is configured to:
receive information indicating whether to switch to the PC5 direct link based on a triggering condition being satisfied; and
the processor is configured to:
determining whether the triggering condition is satisfied; and
trigger the switching from the indirect link to the PC5 direct link based on the triggering condition being satisfied.

14. The WTRU of claim 8, wherein the transmitter/receiver is configured to:
send a domain name system query message include information indicating a proximity-based service (ProSe) for indirect links; and
receive a domain name system response message including the internet protocol address and the user information of the second WTRU.

15. A first Wireless Transmit/Receive Unit (WTRU), comprising:
means for performing a discovery procedure;
means for detecting, based on a result of the performed discovery procedure, that a second WTRU is directly reachable;
means for initiating, following an established indirect link with the second WTRU, establishment of a PC5 direct link with the second WTRU;
means for switching from the indirect link to the PC5 direct link, wherein the means for switching from the indirect link to the PC5 direct link includes means for initiating an indirect-to-direct path switch by sending a message comprising indirect link information; and
means for communicating, with the second WTRU, over the established PC5 direct link after the path switch.

16. (canceled)

17. (canceled)

18. (canceled)

19. (canceled)

20. (canceled)

21. The method of claim 1, wherein the message includes information indicating a type of path switch.

22. The WTRU of claim 8, wherein the message includes information indicating a type of path switch.
